(19) United States
(12) Patent Application Publication
(10) Pub. No.: US 2012/0195384 A1
(43) Pub. Date: Aug. 2, 2012

(54) POWER LINE COMMUNICATION APPARATUS AND NOISE DETECTION METHOD THEREOF

(75) Inventor: Takahiro SATO, Kanagawa (JP)

(73) Assignee: Renesas Electronics Corporation, Kawasaki-shi (JP)

(21) Appl. No.: 13/354,850

(22) Filed: Jan. 20, 2012

(30) Foreign Application Priority Data
Jan. 27, 2011 (JP) 2011-015301

(51) Int. Cl. H04B 3/54; H04B 15/00

(52) U.S. Cl. 375/257

(57) ABSTRACT

A power line communication apparatus and a noise detection method that are capable of detecting noises periodically generated without extending the dynamic range of an A/D converter used therein. The power line communication apparatus according to an embodiment of the present invention includes: a power detection unit that detects powers in communication slots used for transmitting and receiving data via a power line; a channel (transmission line) estimation unit that estimates the condition of a transmission channel on the basis of a difference between an average power through unused slots that are not assigned for transmitting and receiving the data among the communication slots and instantaneous powers regarding the unused slots; and a periodicity determination unit that detects a noise that is periodically generated on the basis of the estimated condition of the transmission channel and an alternating-current cycle in the power line.

### CROSS-REFERENCE TO RELATED APPLICATIONS

The disclosure of Japanese Patent Application No. 2011-15301 filed on Jan. 27, 2011 including the specification, drawings and abstract is incorporated herein by reference in its entirety.

### BACKGROUND

The present invention relates to power line communication apparatuses and noise detection methods, and more particularly to a power line communication apparatus capable of detecting periodic noises and a noise detection method capable of detecting periodic noises.

In recent years, a power line communication that utilizes a power line has become widely used as an interior communication. The power line communication is a communication system that is performed through a medium full of noises. For example, many electric appliances are coupled to a power line. As a result, noises are generated from the electric appliances coupled to the power line, and these generated noises are overlapped with each other, with the result that the sum of the noises becomes large. Among noises generated from electric appliances are impulse noises in sync with alternate currents (referred to as AC cycles hereinafter) in power lines and noises owing to impedance variations. Therefore, in order to improve the communication quality of the power line communication, it is necessary that the power line communication has to be performed to avoid being affected by impulse noises and impedance variations.

A synchronous impulse noise will be explained with reference to FIG. 13. In FIG. 13, the amplitude variation of an example of a synchronous noise signal, which is generated in a power line, is shown while the vertical axis represents the absolute value of the amplitude of the synchronous noise and the horizontal axis represents the time. In addition, an AC cycle is depicted under the above graph showing the amplitude variation of the noise signal. As shown in this figure, the amplitude of the noise signal generated in the power line drastically becomes large in sync with the peak of the amplitude of the AC cycle. A noise generated in sync with an AC cycle in such a manner will be referred to as a synchronous impulse noise. Next, a synchronous impedance variation will be explained with reference to FIG. 14. In FIG. 14, the amplitude variation of a power line signal is shown while the vertical axis represents the absolute value of the amplitude of the power line signal and the horizontal axis represents the time. In addition, an AC cycle is depicted under the above graph showing the amplitude variation of the power line signal. As shown in this figure, the voltage value of the power line signal drastically changes (decreases) in sync with the peak of the amplitude of the AC cycle. This phenomenon occurs owing to the variation (decrease) of loads (impedances) on the power line.

The impulse noise generated in the power line brings about a situation where a large impulse noise is input into an analog-to-digital (A/D) converter, and at the same time the impulse noise input into the A/D converter exceeds the input dynamic range of the A/D converter. In such a situation, it becomes difficult for a time-domain signal to be accurately A/D converted, and the digital signal obtained by the A/D conversion will often represents a rectangular wave when it is afterward D/A converted. Therefore, after the FFT processing is performed on signals to be transmitted, a phenomenon for a SNR over the entire frequency band to deteriorate occurs. However, this phenomenon occurs owning to the operation of the A/D converter, and does not directly indicate the actual quality of the power line.

In order to avoid being affected by impulse noises and the like, a power-line carrier communication apparatus according to Japanese Unexamined Patent Application Publication. No. 2007-258897 discloses a technology in which periodic noises are detected in a MAC layer, and a power line is not used for communication in time slots when the communication quality of the power line is inferior, with the result that the communication quality is improved. An example of a concrete configuration of the power-line carrier communication apparatus according to Japanese Unexamined Patent Application Publication No. 2007-258897 will be explained with reference to FIG. 15. In the power-line carrier communication apparatus, an AFE (analog front-end) 102 receives a signal transmitted via a power line 101. The AFE 102 sends the received signal to an A/D (analog-to-digital conversion unit) 103. The A/D 103 converts the received signal into a digital signal, and sends the digital signal to a signal level measurement unit 105 and a carrier frequency synchronization unit 106 in a physical layer 100. The signal level measurement unit 105 monitors the signal intensity of the digital signal and feedbacks the intensity to the AFE 102. With the use of this intensity, the amplitude of the signal input into the A/D 103 is adjusted.

The carrier frequency synchronization unit 106 abstracts a sync signal from the digital signal, and sends the sync signal to an FFT 107. The FFT 107 converts the received digital signal in time domain to a digital signal in frequency domain. Each subcarrier signal is equalized in a channel estimation unit 108 on the basis of each transmission channel distortion estimated by the channel estimation unit 108. After the equalized signal is demodulated in a subcarrier demodulator 110, error correction processing is performed on the signal in an error correction_decoding unit 111, and the error-corrected signal is sent to a MAC layer 120.

In a case where data is transmitted, encode processing is performed on a signal output from the MAC layer 120 in an error correction_encoding unit 112 so that error correction can be performed on the signal. Next, the signal output from the error correction_encoding unit 112 is sent to an IFFT, in which the IFFT processing is performed on the signal. The signal on which the IFFT processing is performed are converted into an analog signal by a D/A 104, and the analog signal is sent to the AFE 102.

The MAC layer 120 includes a quality control unit 121, a periodic noise determination unit 122, a training unit 123, and a scheduling unit 124. The quality control unit 121 monitors the variation of a transmission channel with the use of information regarding the signal intensity that is monitored in the physical layer 100 and the like. Upon receiving a training command from the quality control unit 121, the training unit 123 performs a predefined training, and informs the scheduling unit of the training result.

The periodic noise determination unit 122 quantitatively captures the condition of the transmission channel per a certain time interval on the basis of the signal intensity, the estimated result of channel distortion or the like obtained in the physical layer 100, and determines a periodic noise. The scheduling unit 124 assigns suitable slots for communication so as to avoid being affected by the periodic noise detected by the periodic noise determination unit 122 to form a frame.

In addition, in a power line communication system according to Japanese Unexamined Patent Application Publication No. 2008-010948, a technology in which an impulse noise and an impedance variation are detected by measuring a received power value of a transmission datum sent from another apparatus is disclosed.

### SUMMARY

However, in a receiving apparatus disclosed in Japanese Unexamined Patent Application Publication No. 2007-258897 or Japanese Unexamined Patent Application Publication No. 2008-010948, an analog signal is converted into a digital signal by an A/D converter, and interferences owing to noises are detected on the basis of an error rate and an SNR of data that is obtained by demodulating the digital signal. In this case, it is necessary that an A/D converter of the receiving apparatus has a wide dynamic range in order to accurately demodulate a reception signal that includes a large impulse noise. Therefore, it is necessary that the A/D converter has a large effective conversion bit number. As a result, the wide dynamic range of the A/D converter leads to the increase of the circuit size of the A/D converter and the increase of power consumption, and there arises a problem in that the cost of the apparatus goes up.

According to one aspect of the present invention, a power line communication apparatus includes: an power detection unit that detects powers in communication slots used for transmitting and receiving data via a power line; a channel (transmission line) estimation unit that estimates the condition of a transmission channel on the basis of an average power through unused communication slots, which are not assigned for transmitting and receiving the data, among the communication slots, and an instantaneous power regarding the unused communication slots; and a periodicity determination unit that detects a noise periodically generated on the basis of the condition of the estimated transmission channel and an alternating-current cycle of the power line.

With the use of the above-described power line communication apparatus, it becomes possible to estimate the condition of a transmission channel on the basis of powers in unused communication slots. Therefore, it is not necessary to accurately demodulate data sent from another apparatus, so that it is possible to detect periodically generated noises without widening the dynamic range of an A/D converter used in the power line communication apparatus.

According to another aspect of the present invention, a noise detection method includes the steps of: detecting powers in communication slots used for transmitting and receiving data via a power line; estimating the condition of a transmission channel on the basis of an average power through unused slots that are not assigned for transmitting and receiving the data among the communication slots, and an instantaneous power regarding the unused slots; and detecting a noise periodically generated on the basis of the estimated condition of the transmission channel and an alternating-current cycle in the power line.

With the use of the above-described noise detection method, it becomes possible to estimate the condition of a transmission channel on the basis of powers in unused communication slots. Therefore, it is not necessary to accurately demodulate data sent from another apparatus, so that it is possible to detect periodically generated noises without widening the dynamic range of an A/D converter used in the power line communication apparatus.

According to the aspects of the present invention there can be provided a power line communication apparatus and a noise detection method that are capable of detecting periodically generated noises without widening the dynamic range of an A/D converter used therein.

### BRIEF DESCRIPTION OF THE DRAWINGS

FIG. 1 is a block diagram of a power line communication apparatus according to a first embodiment of the present invention;

FIG. 2 is a flowchart showing processes regarding a communication request according to the first embodiment;

FIG. 3 is a flowchart showing processes regarding a determination whether a communication slot can be used or not according to the first embodiment;

FIG. 4 is a flowchart showing processes regarding an estimation of the condition of a transmission channel according to the first embodiment;

FIG. 5 is a block diagram of an impulse detection unit according to the first embodiment;

FIG. 6 is a block diagram of an impedance detection unit according to the first embodiment;

FIG. 7A is a flowchart showing processes regarding an detection of an impulse noise according to the first embodiment;

FIG. 7B is a flowchart showing processes regarding an detection of an impedance variation according to the first embodiment;

FIG. 8 is a diagram showing a relationship between an AC cycle and communication slots according to the first embodiment;

FIG. 9 is a diagram showing the configuration a memory of a periodicity determination unit according to the first embodiment;

FIG. 10 is a block diagram of the periodicity determination unit according to the first embodiment;

FIG. 11 is a block diagram of a register of the periodicity determination unit according to the first embodiment;

FIG. 12 is a timing chart regarding operations of the power line communication apparatus according to the first embodiment;

FIG. 13 is a diagram for explaining synchronous impulse noises.

FIG. 14 is a diagram for explaining a synchronous impedance variation; and

FIG. 15 is a block diagram of a power-line carrier communication apparatus according to Japanese Unexamined Patent Application Publication No. 2007-258897.

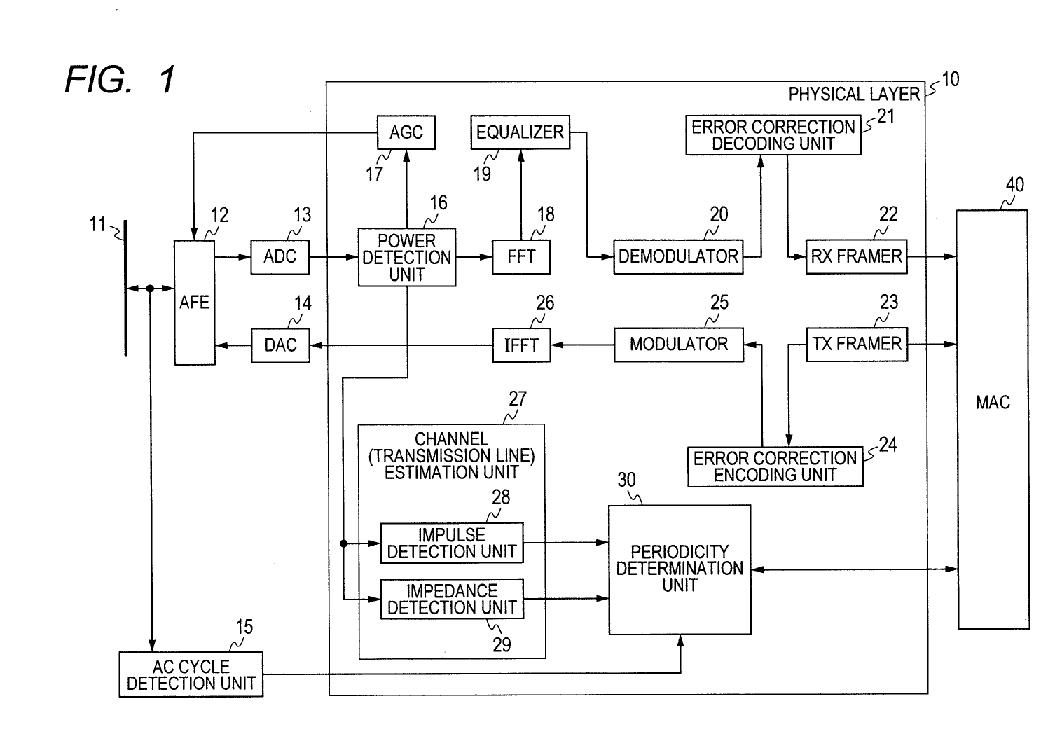

### DETAILED DESCRIPTION

### First Embodiment

An embodiment of the present invention will be explained with reference to the accompanying drawings hereinafter. A power line communication apparatus according to a first embodiment of the present invention includes: a physical layer 10; a power line 11; an AFE (analog front end) 12, an ADC (analog-to-digital conversion unit) 13; a DAC (digital-to-analog conversion unit) 14; an AC cycle detection unit 15; an power detection unit 16; an AGC (automatic gain control) 17; an FFT 18; an equalizer 19; a demodulator 20; an error correction_decoding unit 21; a RX framer 22; a TX framer 23; an error correction_encoding unit 24; a modulator 25; an IFFT 26; a channel (transmission line) estimation unit 27; an impulse detection unit 28; an impedance detection unit 29; a periodicity determination unit 30; and a MAC layer 40.

The AFE 12 receives data sent from other power line communication apparatuses and the like via the power line 11. The AFE 12 receives data, which is sent from other power line communication apparatuses and the like, in the form of analog signals. The AFE 12 sends the received data to the ADC 13. In addition, the AFE 12 transmits the analog signal data, which is sent from the DAC 14, to other power line communication apparatuses and the like via the power line 11.

The ADC 13 converts the data sent from the AFE 12 as analog data into digital signals. The ADC 13 sends the data, which has been converted into the digital signals, to the power detection unit 16. It is conceivable that, if an analog signal with its power exceeding the dynamic range of the ADC 13 enters the ADC 13, the input analog signal is set to be converted into a digital signal representing a specific value.

The power detection unit 16 detects the received power of the digital signal data sent from the ADC 13. Otherwise, the power detection unit 16 detects the received level of the digital signal data sent from the ADC 13. The power detection unit 16 detects the received power per unit of time (in units of communication slots). The power detection unit 16 sends the received power, which it has detected, to the AGC 17 and the channel (transmission line) estimation unit 27. In addition, the power detection unit 16 sends the digital signal data to the FFT 18.

The AGC 17 adjusts the gain of the AFE 12 in accordance with the received power value sent from the power detection unit 16 so that the level of the analog signal, which is output from the AFE 12 and sent to the ADC 13, is kept constant.

The FFT 18 performs the FFT processing on the digital signal data sent from the power detection unit 16. In other worlds, the FFT 18 converts the digital signal data, which represent a time-domain signal, sent from the power detection unit 16 into digital signal data representing a frequency-domain signal. The digital signal data, which are converted into the digital signal data representing the frequency-domain signal, have plural subcarriers. Each subcarrier has a signal having a constant frequency bandwidth. The FFT 18 sends the digital signal data representing the frequency-domain signal to the equalizer 19.

The equalizer 19 performs distortion compensation on the signal distorted owing to a transmission channel such as the power line 11. The equalizer 19 sends the digital signal data, on which the distortion compensation is performed, to the demodulator 20. The demodulator 20 demodulates the received digital signal data. The demodulator 20 sends the signal obtained by the above demodulation to the error correction_decoding unit 21. The error correction_decoding unit 21 performs error detection on the demodulated signal sent by the demodulator 20, and corrects detected errors. The error correction_decoding unit 21 sends the signal on which the error correction has been performed to the MAC layer 40 via the RX framer 22.

When data communication is performed, the TX framer 23 sends the data it received from the MAC layer 40 to the error correction_encoding unit 24. The error correction_encoding unit 24 performs encoding processing on the data it received so that error correction can be performed on the data, and sends the processed data to the modulator 25. The modulator 25 modulates the received data, and sends the modulated data to the IFFT 26. The IFFT 26 performs IFFT processing on the data sent from the modulator 25, that is to say, converts the data representing a frequency-domain signal into data representing a frequency-domain signal. The DAC 14 converts the digital signal data it received from the IFFT 26 into an analog signal and sends the analog signal to the AFE 12.

Next, the function of the channel (transmission line) estimation unit 27 and the periodicity determination unit 30 will be explained hereinafter. The channel (transmission line) estimation unit 27 includes the impulse detection unit 28 and the impedance detection unit 29. The channel (transmission line) estimation unit 27 receives information regarding the received power values detected by the power detection unit 16. The channel (transmission line) estimation unit 27 receives information regarding a received power value for each communication slot. The channel (transmission line) estimation unit 27 estimates the condition of the transmission channel on the basis of received power values in unused communication slots that are not assigned for transmitting and receiving data.

Here, an explanation regarding an unused slot will be made. It will be assumed that a unit of time obtained by dividing a period of an AC cycle by an arbitrary integer number is a slot, and an unused slot is defined as a slot that is not used for transmitting and receiving data via the power line 11.

In the channel (transmission line) estimation unit 27, the impulse detection unit 28 and the impedance detection unit 29 receive the information regarding received power values sent from the power detection unit 16.

The impulse detection unit 28 detects an impulse noise on the basis of a difference between an average power through unused slots during a predetermined time period and an instantaneous power regarding the unused slots. The average power through the unused slots represents an average value of received powers in plural unused slots. The instantaneous power regarding the unused slots is, for example, a received power in one of the unused slots. Alternatively, the instantaneous power can be an average received power of received powers in unused slots whose number is less than the number of the plural unused slots used for calculation of the average power. The impulse detection unit 28 can determine that an impulse noise is being generated if the ratio of an instantaneous power to an average power exceeds a predetermined threshold value.

The impedance detection unit 29 detects an impedance variation on the basis of an average power through the unused slots during a predetermined time period and an average power through the unused slots during a time period shorter than the predetermined time period used for calculation of the average power through the unused slots. Here, the average power through the unused slots during a time period shorter than the predetermined time period used for calculation of the average power through the unused slots is defined as a quasi-instantaneous power. The impedance variation unit 29 can determine that an impedance variation is being generated if the ratio of a quasi-instantaneous power to an average power is less than a predetermined threshold value.

The impulse detection unit 28 and the impedance detection unit 29 send the result of the impulse detection processing regarding the unused slots and the result of the impedance variation detection processing regarding the unused slots respectively to the periodicity determination unit 30. For example, the impulse detection unit 28 can send a high-level signal to the periodicity determination unit 30 if it detects an impulse noise, and can send a low-level signal to the periodicity determination unit 30 if it does not detect an impulse noise. The impedance detection unit 29 can also operate in the similar way.

The AC cycle detection unit 15 detects an AC cycle with the use of the analog signal sent from the power line 11. For example, the AC cycle detection unit 15 can detect the AC cycle by detecting a communication slot in which the received power of the analog signal becomes zero. The AC cycle detection unit 15 sends the detection result of the AC cycle to the periodicity determination unit 30.

The periodicity determination unit 30 detects a noise periodically generated with the use of the detection result of the AC cycle, the detection result of the impulse noise, and the detection result of the impedance variation. The periodicity determination unit 30 determines whether there are impulse noises and impedance variations that are periodically generated over plural periods of the AC cycle or not. The impulse noises and impedance variations that are periodically generated over plural periods of the AC cycle will be referred to as periodic noises hereinafter. The periodicity determination unit 30 sends information regarding whether periodic noises are generated or not to the MAC layer 40. The MAC layer 40 stores the information regarding whether periodic noises are generated or not in a memory or the like of the MAC layer 40.

The MAC layer 40 assigns suitable communication slots for communication so as not to assign communication slots in which periodic noises are being generated for communication.

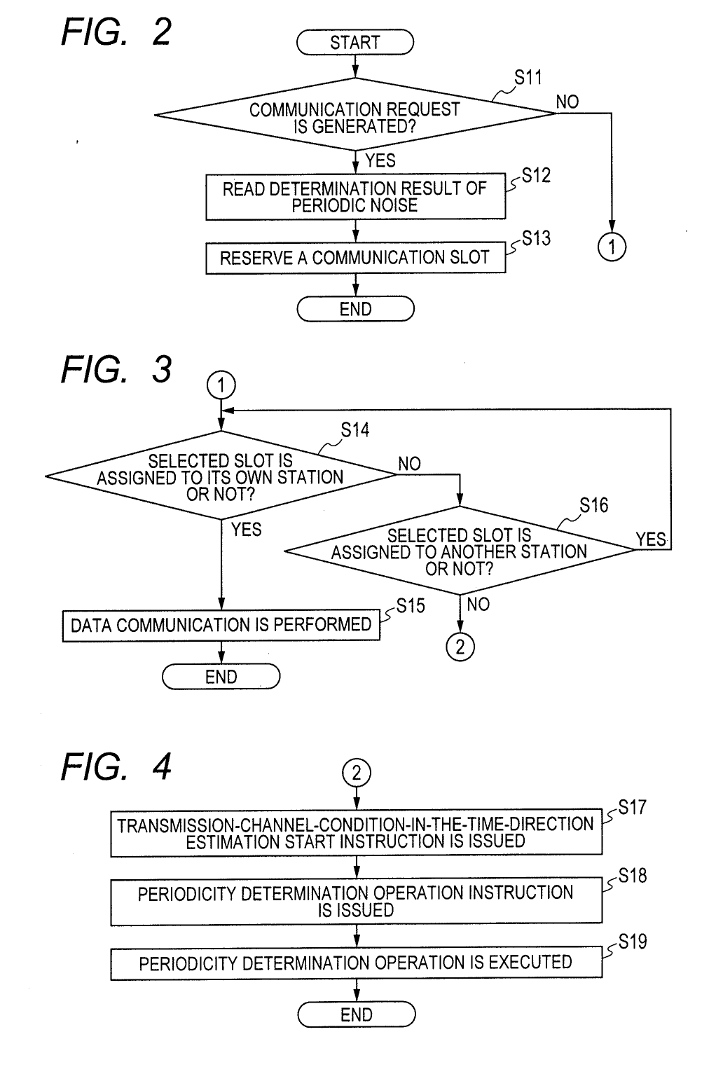

Next, a flow showing processes regarding a communication request according to the first embodiment of the present invention will be explained with reference to FIG. 2. First, the control unit (not shown) of the MAC layer 40 determines whether a communication request to another power line communication apparatus is generated or not. If the communication request is generated, the control unit of the MAC layer 40 reads out information regarding whether periodic noises are generated or not, which has been determined by the periodicity determination unit 30, from the memory of the MAC layer 40 (S12). Next, the control unit of the MAC 40 reserves a communication slot in which a periodic noise is not being generated to assign for transmitting data (S13). At step S11, if there is no communication request, the flow proceeds to a determination process to determine whether a communication slot can be used or not as shown in FIG. 3.

Next, a flow showing processes regarding a determination whether a communication slot can be used or not according to the first embodiment of the present invention with reference to FIG. 3. The control unit of the MAC layer 40 selects a given communication slot, and determines whether the selected slot is assigned to its own station or not (S14). In other words, the control unit of the MAC layer 40 determines whether data destined for its own station is set in the selected communication slot. If the selected slot is assigned to its own station, the control unit of the MAC layer 40 performs data communication processing regarding data reception (S15). If the selected slot is not assigned to its own station, the control unit of the MAC layer 40 determines whether the selected slot is to be used by another power line communication apparatus or data destined for another power line communication apparatus is set in the selected communication slot (S16). If the selected slot is to be used by another power line communication apparatus or data destined for another power line communication apparatus is set in the selected communication slot, the flow goes back to step S14. If the selected communication slot is not to be used by another power line communication apparatus and data destined for another power line communication apparatus is not set in the selected communication slot, the flow proceeds to the process of the transmission channel condition estimation shown in FIG. 4.

Here, the control unit of the MAC layer 40 can be informed of information regarding whether data destined for its own station is set in the selected communication slot or not; whether the selected slot is assigned to its own station or not; whether the selected slot is to be used by another power line communication apparatus or not; or data destined for another power line communication apparatus is set in the selected communication slot or not by a beacon signal sent from another power line communication apparatus that operates as a master apparatus. Alternatively, the control unit of the MAC layer 40 can be informed of unused slots with the use of a beacon signal. Alternatively, it is also conceivable that unused slots are determined in advance, and all the power line communication apparatuses recognize the positions of the unused slots in advance. The master apparatus can regularly send beacon signals to power line communication apparatuses coupled to the power line 11.

Next, a flow showing processes regarding an estimation of the condition of a transmission channel according to the first embodiment of the present invention will be explained with reference to FIG. 4. When an unused slot is selected in FIG. 3, the periodicity determination unit 30 receives a transmission-channel-condition-in-the-time-direction estimation start instruction from the control unit of the MAC layer 40 (S17). Next, the control unit of the physical layer 10 issues a periodic-noise-detection operation execution instruction to the periodicity determination unit 30 (S18). Next the periodicity determination unit 30 executes the periodic noise detection operation (S19). The periodic noise detection operation is executed by the periodicity determination unit 30 determining whether there is a periodic noise or not with reference to a memory or the like in which detection results of impulse noises sent from the impulse detection unit 28 or from the impedance detection unit 29 are stored. Alternatively, the periodicity determination unit 30 can determines whether there is a periodic noise or not by collecting the detection results of the impulse noises and the like from the impulse detection unit 28 or from the impedance detection unit 29.

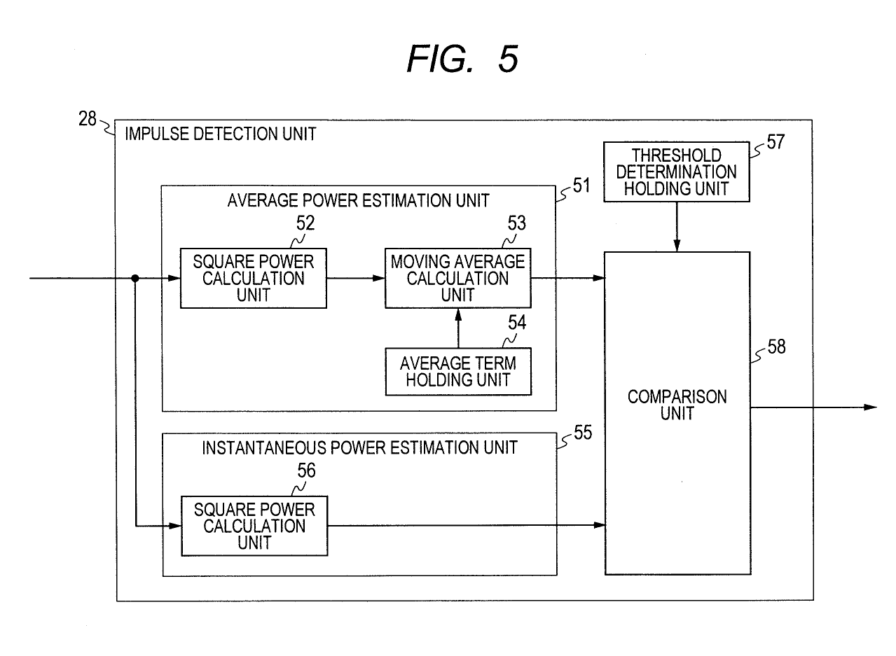

Next, a configuration example of the impulse detection unit 28 according to the first embodiment of the present invention will be explained with reference to FIG. 5. The impulse detection unit 28 includes an average power estimation unit 51, an instantaneous power estimation unit 55, a threshold determination holding unit 57, and a comparison unit 58. In addition, the average power estimation unit 51 includes a square power calculation unit 52, a moving average calculation unit 53, and an average term holding unit 54, and the instantaneous power estimation unit 55 includes a square power calculation unit 56.

The square power calculation unit 52 of the average power estimation unit 51 receives information regarding the received power values of the digital data sent from the power detection unit 16. The square power calculation unit 52 calculates square powers using the received power values. The square power calculation unit 52 calculates a square power per communication slot. The square power calculation unit 52 sends information regarding values of the calculated square powers to the moving average calculation unit 53.

The average term holding unit 54 holds information regarding a time interval or a time period through which an average power is calculated. For example, it is conceivable that the average term holding unit 54 holds the number of communication slots through which an average power is calculated. The communication slots through which the average power is calculated are unused communication slots. The average term holding unit 54 sends the information regarding the time interval or the time period through which the average power is calculated to the moving average calculation unit 53.

The moving average calculation unit 53 calculates an average power through a time interval or a time period with the use of squared powers during the time interval or the time period which is sent by the average term holding unit 54 and through which the average power is calculated. The moving average calculation unit 53 sends information regarding the calculated average power to the comparison unit 58.

The square power calculation unit 56 of the instantaneous power estimation unit 55 receives information regarding the received power values of the digital data sent from the power detection unit 16, and calculates square powers using the received power values in the same way as the square power calculation unit 52 of the average power estimation unit 51 does. The square power calculation unit 56 sends the calculated square power values to the comparison unit 58. In this figure, although the average power estimation unit 51 and the instantaneous power estimation unit 55 respectively have their own square power calculation units, it is conceivable that one square power calculation unit is shared by both average power estimation unit 51 and instantaneous power estimation unit 55.

The comparison unit 58 determines whether an impulse noise is being generated or not on the basis of the average power calculated by the average power estimation unit 51 and the instantaneous power calculated by the instantaneous power estimation unit 55. For example, the comparison unit 58 determines that an impulse noise is being generated in a communication slot where the instantaneous power is calculated if the ratio of the instantaneous power to the average power is larger than a predetermined value. The predetermined value used for determining whether an impulse noise is being generated or not is held in the threshold determination holding unit 57. The comparison unit 58 determines whether an impulse noise is generated or not by judging whether the ratio of an instantaneous power to an average power is larger than a value sent from the threshold determination holding unit 57. The comparison unit 58 sends information regarding whether an impulse noise is generated or not to the periodicity determination unit 30.

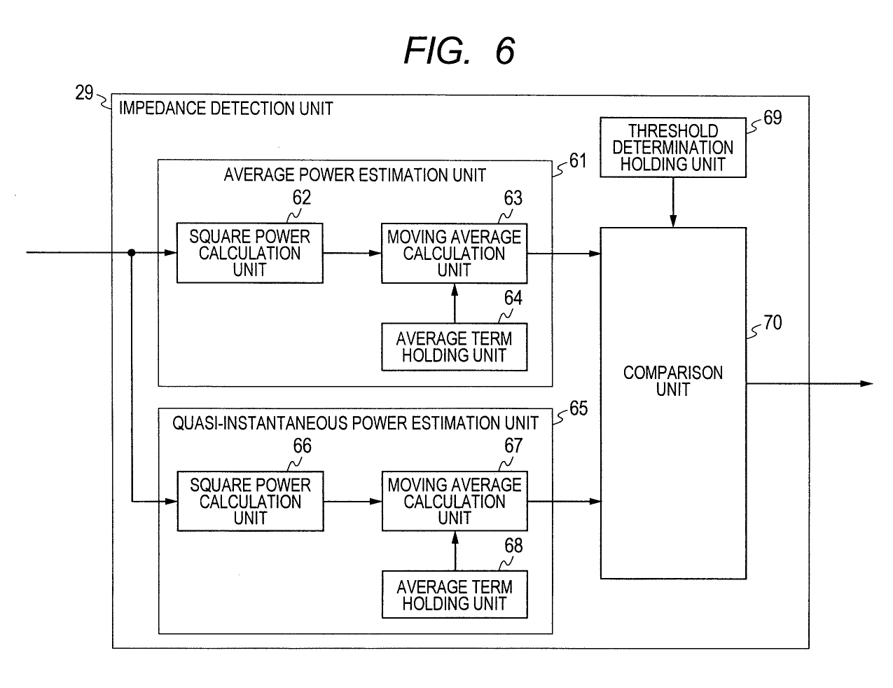

Next, a configuration example of the impedance detection unit 29 according to the first embodiment of the present invention will be explained with reference to FIG. 6. The impedance detection unit 29 includes an average power estimation unit 61, quasi-instantaneous power estimation unit 65, a threshold determination holding unit 69, and a comparison unit 70. The average power estimation unit 61 includes a square power calculation unit 62, a moving average calculation unit 63, and an average term holding unit 64, and the quasi-instantaneous power estimation unit 65 includes a square power calculation unit 66, a square power calculation unit 66, a moving average calculation unit 67, and an average term holding unit 68.

Because the units included in the average power estimation unit 61 and the units included in the quasi-instantaneous power estimation unit 65 are respectively similar to those included in the average power estimation unit 51 of the impulse detection unit 28, detailed explanations about these units will be omitted. Here, the difference between the moving average calculation unit 63 of the average power estimation unit 61 and the moving average calculation unit 67 of the quasi-instantaneous power estimation unit 65 will be explained. The moving average calculation unit 63 calculates an average power through a time interval longer than a time interval used for the calculation by the moving average calculation unit 67. In the impedance detection unit 29, a power calculated by the moving average calculation unit 67, that is, an average power calculated through a time interval shorter than a time interval used for calculation by the moving average calculation unit 63 is sent to the comparison unit 70 as an instantaneous power.

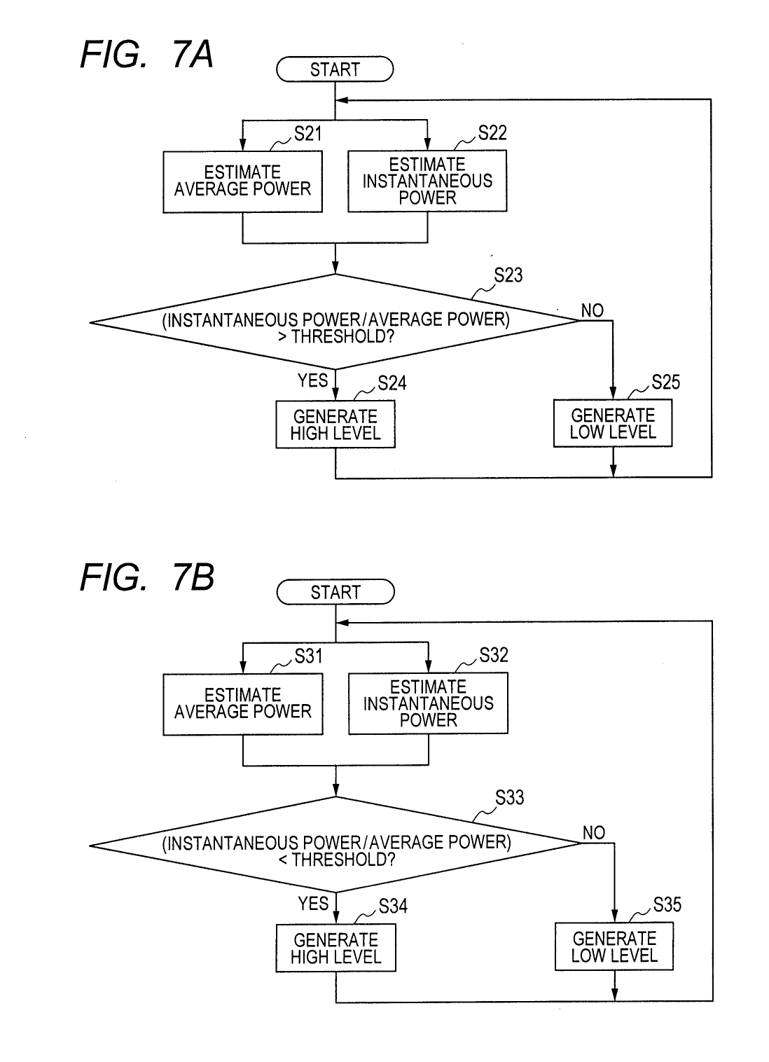

A flow showing processes regarding an detection of an impulse noise according to the first embodiment of the present invention will be explained with reference to FIG. 7A. First, the average power estimation unit 51 of the impulse detection unit 28 calculates an average power of a received noise signal for a predetermined time interval (S21). In addition, in parallel with the above calculation, the instantaneous power estimation unit 55 of the impulse detection unit 28 calculates an instantaneous power of the received noise signal (S22). Next, the comparison unit 58 determines whether the ratio of the instantaneous power to the average power is larger than a threshold predetermined in the threshold determination holding unit 57 or not (S23). If the ratio of the instantaneous power to the average power is larger than the threshold predetermined in the threshold determination holding unit 57 (in the case where a conditional expression at step S23 is satisfied), the impulse detection unit 28 sends a High level signal to the periodicity determination unit 30 (S24). If the ratio of the instantaneous power to the average power is smaller than the threshold predetermined in the threshold determination holding unit 57 (in the case where the conditional expression at step S23 is not satisfied), the impulse detection unit 28 sends a Low level signal to the periodicity determination unit 30 (S25).

A flow showing processes regarding a detection of an impedance variation according to the first embodiment of the present invention will be explained with reference to FIG. 7B. First, the average power estimation unit 61 of the impedance detection unit 29 calculates an average power of a received noise signal for a predetermined time interval (S31). In addition, in parallel with the above calculation, the quasi-instantaneous power estimation unit 65 of the impedance detection unit 29 calculates a quasi-instantaneous power of the received noise signal (S32). Next, the comparison unit 70 determines whether the ratio of the quasi-instantaneous power to the average power is smaller than a threshold predetermined in the threshold determination holding unit 69 or not (S33). If the ratio of the quasi-instantaneous power to the average power is smaller than the threshold predetermined in the threshold determination holding unit 69 (in the case where a conditional expression at step S33 is satisfied), the impedance detection unit 29 sends a High level signal to the periodicity determination unit 30 (S34). If the ratio of the quasi-instantaneous power to the average power is larger than the threshold predetermined in the threshold determination holding unit 69 (in the case where the conditional expression at step S33 is not satisfied), the impedance detection unit 29 sends a Low level signal to the periodicity determination unit 30 (S35).

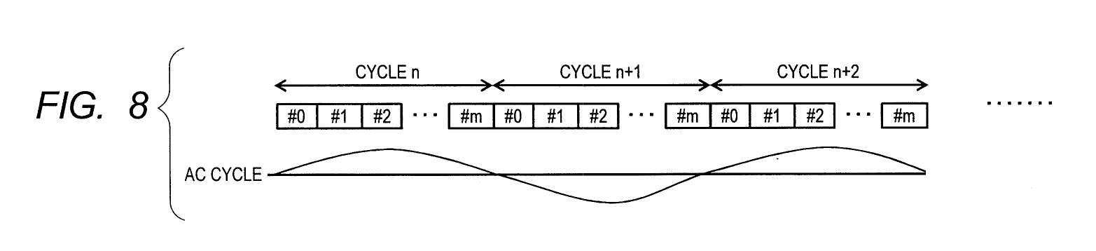

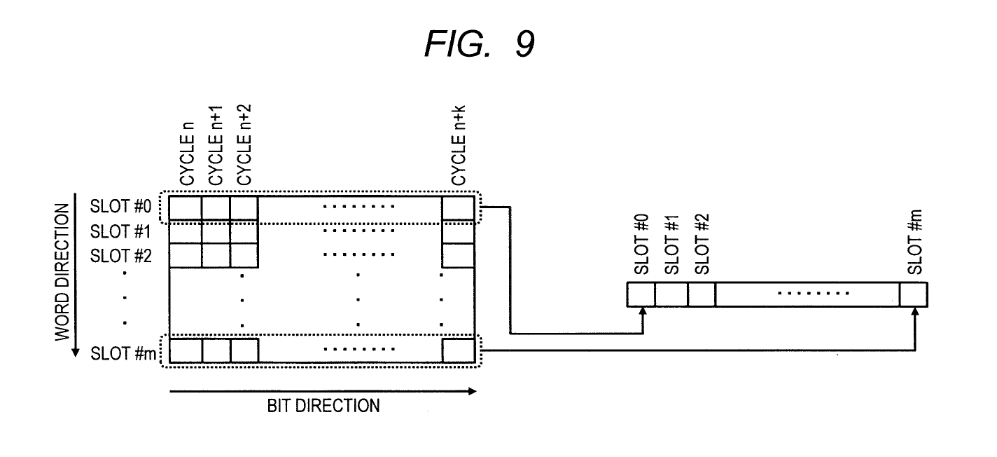

Next, the outline of processes performed by the periodicity determination unit 30 according to the first embodiment of the present invention will be explained with reference to FIG. 8 and FIG. 9. FIG. 8 shows periodic communication slots. One cycle is a time period from a zero crossover point of an AC cycle to the next zero crossover point in FIG. 8. As shown in this figure, there are communication slots #0 to #m (where m is a natural number) in one cycle. In FIG. 8, Cycle n to Cycle n+2 are shown (where n is a natural number).

FIG. 9 shows the configuration of a memory of the periodicity determination unit 30. The memory of the periodicity determination unit 30 respectively manages output values of communication slots #0 to #m at cycles n to n+k (k is a natural number) in association with bit positions of the memory. To put it concretely, the output value of communication slot #i at cycle j is stored in a bit position (i, j) of the memory as shown in FIG. 9. In this figure, it will be assumed that a direction along which the slot number increases coincides with the word direction, and a direction along which the cycle number increases coincides with the bit direction. In addition, registers of the periodicity determination unit 30 respectively compare the total sums of output values accumulated in the bit direction in units of slots with a predetermined threshold, and hold the determination results. The periodicity determination unit 30 detects periodic noises with the use of the determination results.

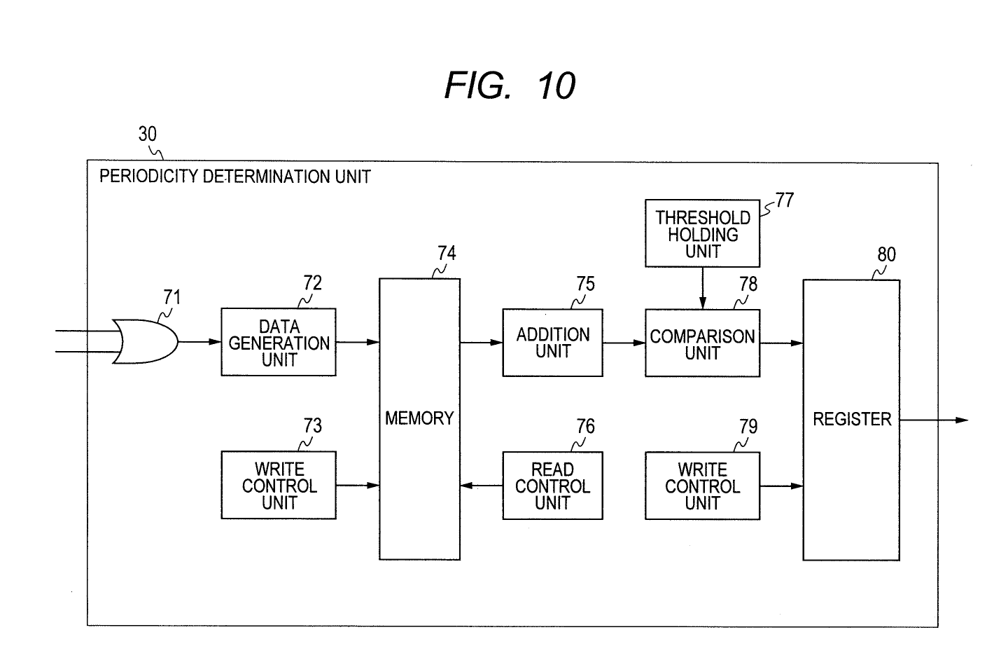

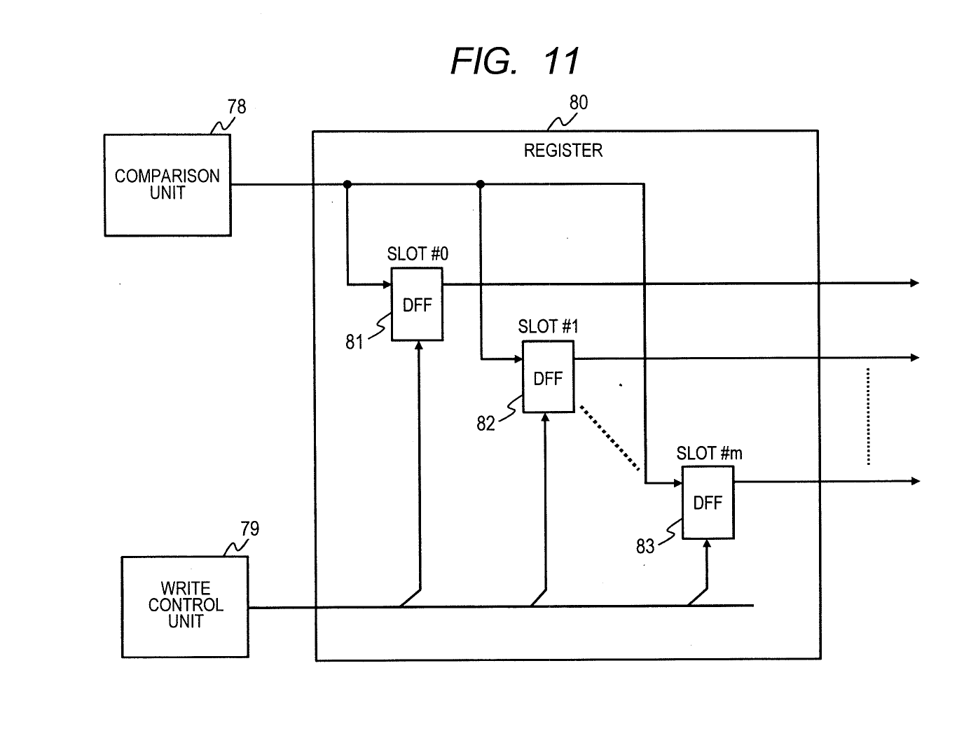

Next, a configuration example of the periodicity determination unit 30 according to the first embodiment of the present invention will be explained with reference to FIG. 10. The periodicity determination unit 30 includes an OR circuit 71, a data generation unit 72, a write control unit 73, a memory 74, an addition unit 75, read control unit 76, a threshold holding unit 77, a comparison unit 78, a write control unit 79, and a register 80.

The OR circuit 71 receives the detection result of an impulse noise from the impulse detection unit 28 and the detection result of an impedance variation from the impedance detection unit 29. Upon receiving at least one of the detection result telling that there is an impulse noise from the impulse detection unit 28 and the detection result telling that there is an impedance variation from the impedance detection unit 29, the OR circuit 71 sends a High level signal telling the existence of a noise to the data generation unit 72.

The data generation unit 72 determines a bit position in the memory 74 in which the noise detection result sent from the OR circuit 71 is written. If the noise is detected in the communication slot #i at the cycle j, the bit position in the memory 74 is determined by the number i of the communication slot and the number j of the cycle. The data generation unit 72 writes the noise detection result sent from the OR circuit 71 in the determined bit position in the memory 74. The write control unit 73 controls a timing at which the data generation unit 72 writes the noise detection result in the memory 74.

As explained with reference to FIG. 9, the memory 74 holds the noise detection result output from the data generation unit 72 in the bit position determined by the number of the communication slot and the number of the cycle.

The addition unit 75 accumulates values held by bits in the memory 74 along the bit direction per slot. Each bit holds a value “1” which indicates that a noise is detected, or a value “0” which indicates that a noise is not detected. The read control unit 76 controls a timing at which the addition unit 75 reads a datum in the memory 74. The addition unit 75 sends the value obtained by accumulating the values to the comparison unit 78.

The comparison unit 78 compares a threshold held in the threshold holding unit 77 with the value output by the addition unit 75, and determines whether there is a periodic noise or not. If the value output by the addition unit 75 is larger than the threshold, the comparison unit 78 informs the register 80 that a periodic noise is being generated in the relevant communication slot. If the value output by the addition unit 75 is not larger than the threshold, the comparison unit 78 informs the register 80 that a periodic noise is not being generated in the relevant communication slot. The write control unit 79 controls a timing at which the comparison unit 78 informs (writes into) the register 80 whether a periodic noise is not generated or not.

The register 80 holds information regarding whether a periodic noise is generated or not, which is provided by the comparison unit 78, and sends the information to the MAC layer 40.

Next, a configuration example of the register 80 according to the first embodiment of the present invention will be explained with reference to FIG. 10. The register 80 includes a D flip-flop (DFF) for holding a periodicity determination result per communication slot. In this figure, DFF 81 corresponds to the communication slot #0, a DFF 82 to the communication slot #1, a DFF 83 to the communication slot #m. The DFF 81 to 83 respectively hold the values sent by the comparison unit 78 at the timing provided by the write control unit 79, and respectively send the held values to the MAC layer 40.

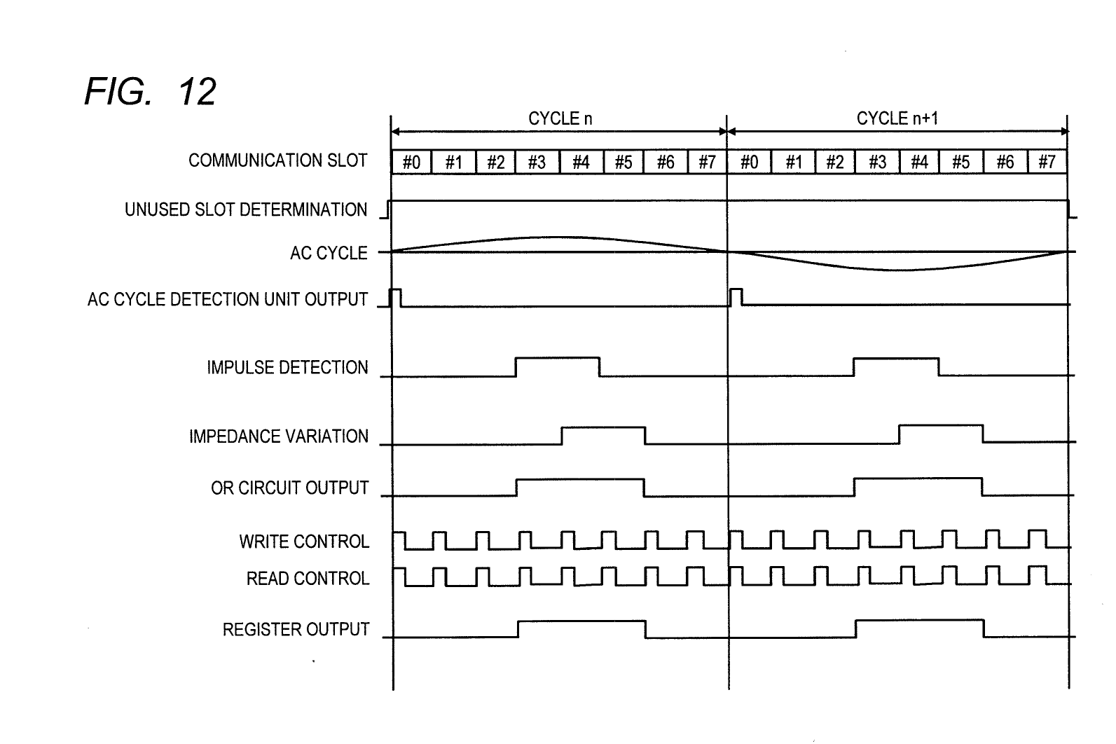

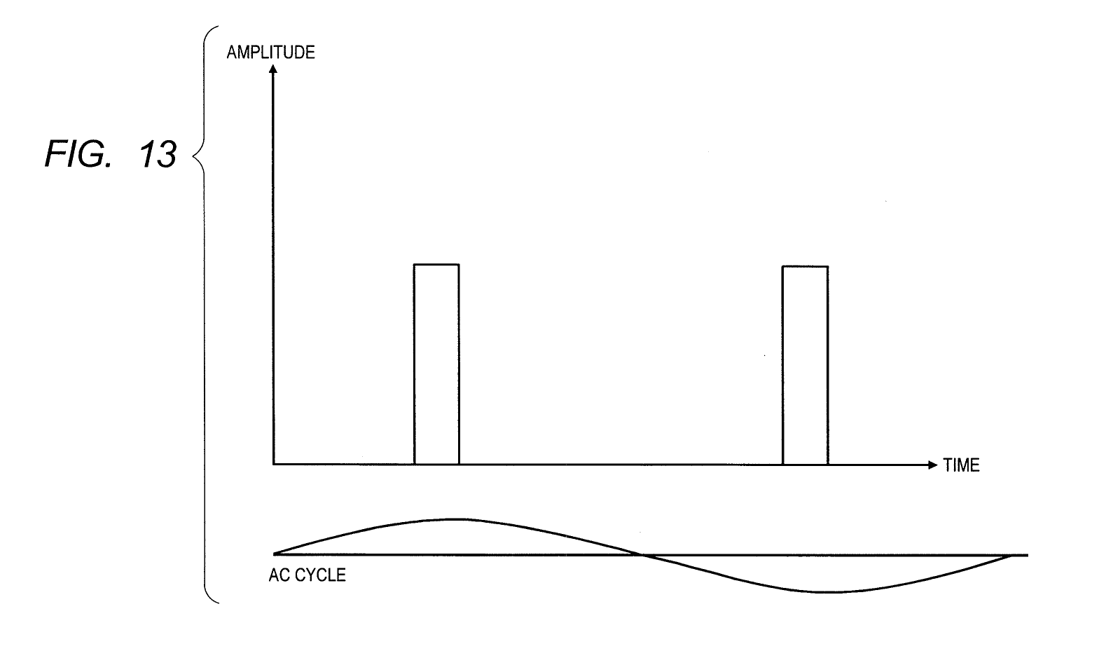

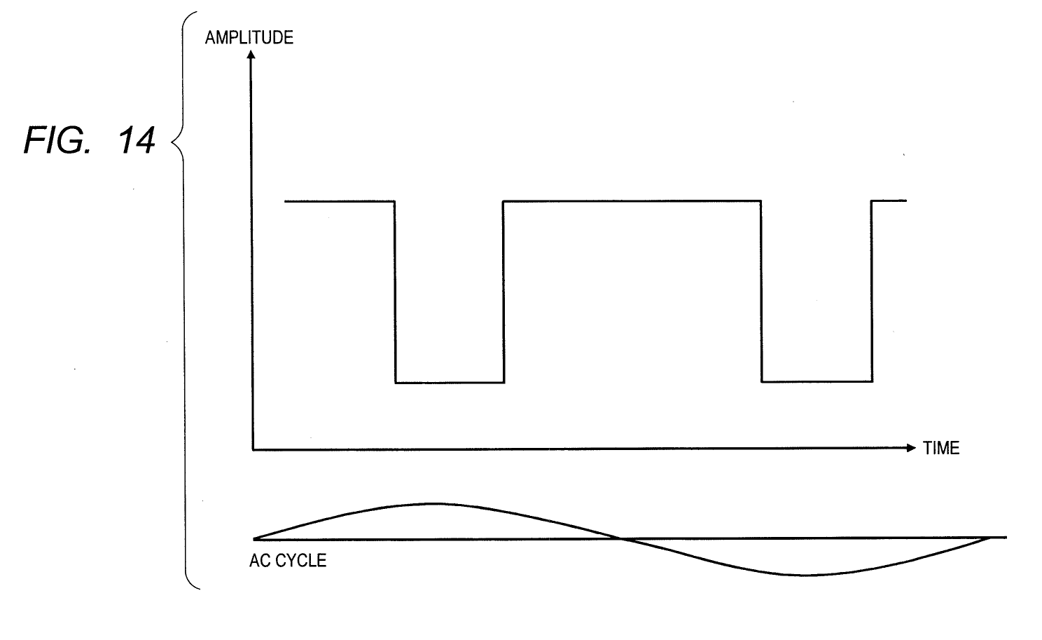

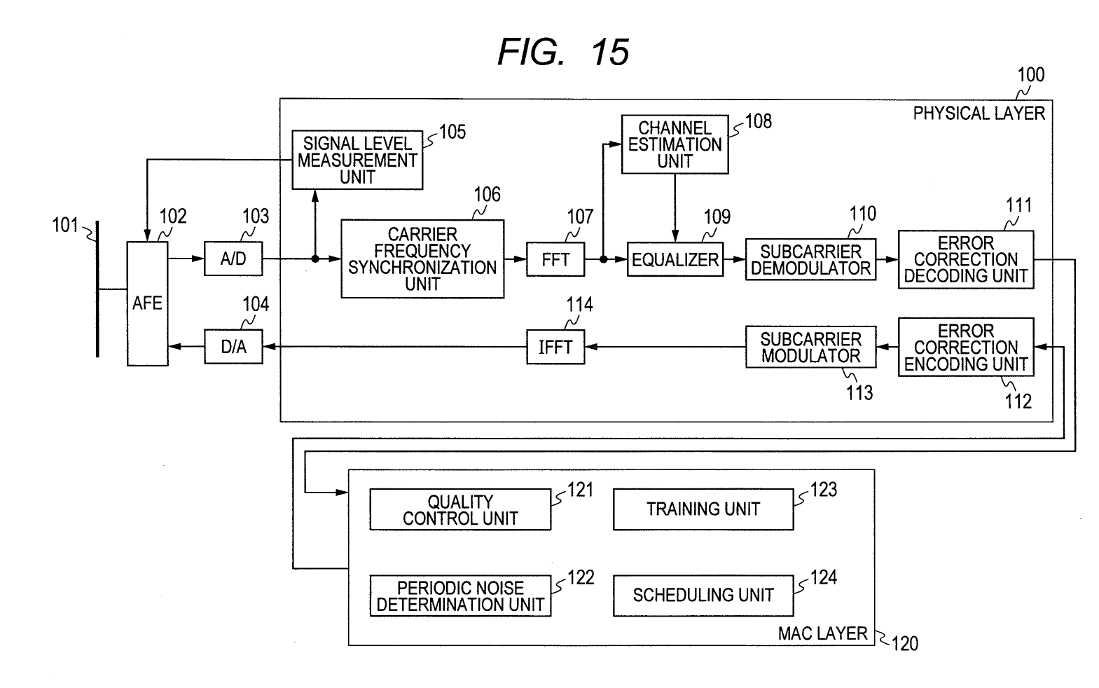

Next, a timing chart regarding operations of the power line communication apparatus according to the first embodiment of the present invention will be explained with reference to FIG. 12. In this figure, it will be assumed that there are eight communication slots in one cycle. Unused slot determination, which is provided by a beacon signal or the like, shows that the slot is used or not. The High level signal shows that the communication slot is unused, and the Low level signal shows that the communication slot is used. FIG. 12 shows that slots #0 to #7 at a cycle n and slots #0 to #7 at a cycle n+1 are unused.

An AC cycle represents an alternating signal on a power line. An AC cycle detection unit output becomes a High level at a zero crossover point of the AC cycle. An impulse detection becomes a High level in communication slots where an impulse noise is detected by the impulse detection unit 28. An impedance variation becomes a High level in communication slots where an impedance variation is detected by the impedance detection unit 29.

An OR circuit output becomes a High level when it is determined that a noise is detected by the OR circuit 71. In FIG. 12, it is determined that a noise is detected in a communication slot where an impulse noise is detected, or in a communication slot where an impedance variation is detected. A write control and a read control respectively show a timing at which a datum is written to each communication slot and a timing at which a datum is read from each communication slot. A register output becomes a High level when a periodic noise is detected in the register 80, and becomes a Low level when a periodic noise is not detected in the register 80.

As explained above, with the use of the power line communication apparatus according to the first embodiment of the present invention, it can be determined whether periodic noises are being generated or not using values of received powers in unused slots on which the FFT processing has not been performed yet. Therefore, the generation of the periodic noises can be detected without widening the dynamic range of the ADC 13 in order to accurately perform the FFT processing, the demodulation processing and the like on data sent from another apparatus.

In addition, the present invention is not limited to the above-described embodiments, and proper modifications may be made to the above-described embodiments without departing from the spirit and scope of the present invention.

What is claimed is:

1. A power line communication apparatus, comprising:
a power detection unit that detects powers in communication slots used for transmitting and receiving data via a power line;
a channel estimation unit that estimates the condition of a transmission channel on the basis of an average power through unused slots, which are not assigned for transmitting and receiving the data, among the communication slots, and an instantaneous power regarding the unused slots; and
a periodicity determination unit that detects a noise periodically generated on the basis of the estimated condition of the transmission channel and an alternating-current (AC) cycle of the power line.

2. The power line communication apparatus according to claim 1,
wherein the channel estimation unit includes:
an impulse detection unit that detects an impulse noise generated in the transmission channel on the basis of the ratio of the average power through the unused slots to the instantaneous power regarding the unused slot.

3. The power line communication apparatus according to claim 1,
wherein the channel estimation unit further includes:
an impedance detection unit that detects an impedance variation in the transmission channel on the basis of the ratio of a first average power through the unused slots during a predetermined time period to a second average power through the unused slots during a time period shorter than the predetermined time period.

4. The power line communication apparatus according to claim 3,
wherein the periodicity determination unit, which detects communication slots where noises are periodically generated, further includes:
an assignment control unit that assigns a communication slot, which is other than the communication slots where noises are generated, for transmitting and receiving the data.

5. The power line communication apparatus according to claim 4, wherein the periodicity determination unit stores the condition of the transmission channel estimated by the channel estimation unit per unit of time, and detects the noises that are periodically generated with the use of a plurality of the conditions of the transmission channel stored by the periodicity determination unit and the alternating-current cycle of the power line.

6. The power line communication apparatus according to claim 5, wherein the periodicity determination unit detects noises that are periodically generated with the use of the unused slots, in each of which at least either one of an impulse noise and an impedance variation is detected by the channel estimation unit, and the AC cycle of the power line.

7. The power line communication apparatus according to claim 6, wherein the unused slots are not assigned for transmitting and receiving data either in the power line communication apparatus or in other power line communication apparatuses other than the power line communication apparatus.

8. The power line communication apparatus according to claim 7, wherein the assignment control unit determines the positions of the unused slots on the basis of a beacon signal sent to the power line communication apparatus.

9. The power line communication apparatus according to claim 1, wherein the channel estimation unit and the periodicity determination unit are disposed in a physical layer and the assignment control unit is disposed in a MAC layer.

10. A system comprising:
an average power calculation unit configured to calculate an average noise power on a power line;
an instantaneous power calculation unit configured to calculate an instantaneous noise power on the power line;
a periodicity determination unit configured to store a plurality of detection results based on a power ratio between the average noise power and the instantaneous noise power; and
a control unit configured to manage a plurality of communication slots on the power line in response to the detection results.

11. The system according to claim 10, further comprising:
an impedance detection unit configured to estimate an impedance deviation of the power line,
wherein the periodicity determination unit further configured to store a plurality of estimation results of the impedance detection unit, and
wherein the control unit manages the communication slots in response to the detection results and the estimation results.

12. The system according to claim 11,
wherein the impedance detection unit estimates the impedance deviation based on a power ratio between a first average noise power and a second average noise power having a different averaging period of time from the first averaging noise power.

13. A noise detection method comprising:
detecting powers in communication slots used for transmitting and receiving data via a power line;
estimating the condition of a transmission channel on the basis of an average power through unused slots that are not assigned for transmitting and receiving the data among the communication slots, and an instantaneous power regarding the unused slots; and
detecting a noise that is periodically generated on the basis of the estimated condition of the transmission channel and an alternating-current cycle in the power line.
